(19) United States
(12) Patent Application Publication
(10) Pub. No.: US 2009/0202179 A1
(43) Pub. Date: Aug. 13, 2009

(54) METHOD AND SYSTEM FOR PROVIDING REGION BASED IMAGE MODIFICATION

(75) Inventors: Vikram Shivanna, Bangalore (IN); Madhavi K., Bangalore (IN)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 12/030,709

(22) Filed: Feb. 13, 2008

(51) Int. Cl. G06K 9/03

(52) U.S. Cl. 382/311

(57) ABSTRACT

A method and system for providing a region based image modification method and system for performing the same. The method includes: selecting at least one region of interest of an image and editing image attributes of the selected region of interest. The edited region of interest is saved separately without affecting the image. The saved regions of interest acts as individual images having their own image attributes and display characteristics. The edited region of interest and original image can be retrieved at later stage without affecting each other.

### FIELD OF THE INVENTION

This invention relates generally to image modifications, and more particularly to, a method and system for providing region based image modification along with retrieval and retention of the modified regions.

### BACKGROUND OF THE INVENTION

With advanced imaging techniques, identifying problems through investigation of images has become very popular. It is essential to investigate the images appropriately to yield a better and accurate result.

In medical diagnosis, proper evaluation of medical images is critical. While diagnosing, the physician may need to examine a particular part of the image in detail. For example, the doctor may select a region of interest of an image and would like to study that region of interest. The doctor may perform different processing techniques to improve the quality or visibility of the selected region of interest. This could include changing the image attributes, size or display parameters of the region of interest. Once the physician completes the study he may want to save the changes made to the selected regions of interest.

Some of the available imaging tools allow processing techniques to be applied to the selected regions of interest. However, while saving the changes in the region of interest, the original image also gets updated with the changes in those regions. For example, with an imaging tool, the doctor will be able to zoom into the image, or make any changes to the properties of the image like, sharpness or brightness, etc. This will change the properties of the entire image rather than only the modified region of interest. Similarly there are other techniques where regions can be selected and edited. However, once editing is done to the regions, the changes are imprinted to the original image and it will be difficult to retain the original image.

Hence it would be beneficial to have a method to edit parts of an image and retain the changes incorporated in different parts of the image without affecting the original image.

Thus there exists a need to provide a method and system for facilitating region based image modification, without affecting the image but still retaining the changes incorporated to the regions.

### SUMMARY OF THE INVENTION

The above-mentioned shortcomings, disadvantages and problems are addressed herein which will be understood by reading and understanding the following specification.

In one embodiment, the present invention provides a region based image modification method. The method comprises: selecting at least one region of interest of an image; editing image parameters of the selected region of interest; and saving the changes in the region of interest separately without affecting the image.

In another embodiment, a tool for region based image modification is disclosed. The tool comprises: a selector for selecting at least one region of interest of an image; and a processor. The processor is configured to edit the selected region of interest without affecting other parts of the image, and is further configured to save the edited region of interest and the original image separately.

In yet another embodiment, a diagnostic decision support method is provided. The method comprises: providing a medical image to a user; selecting at least one region of interest of the image; editing the selected region of interest for assisting in diagnosis; and saving the region of interest and the image separately as individual images to enable retrieval of the edited region of interest and the original unchanged image.

In yet another embodiment, an image management system is disclosed. The system comprises: a picture archival and communications system (PACS) server having a plurality of inputs and outputs, the inputs configured to receive image information signals and the outputs configured to provide image output signals; an image source having outputs coupled to at least one of the inputs of the PACS server, and configured to provide an image signal for storing images at the PACS server; and a PACS workstation having an input coupled to at least one of the outputs of the PACS server, and configured to receive the images from the server, and further configured to edit a selected a region of interest and store the edited region of interest without affecting the image on to the PACS server.

In yet another embodiment, the invention provides a computer readable media having one or more computer readable medium for performing region based image modification. The media comprises: a routine for selecting at least one region of interest of an image; a routine for editing image parameters of the selected region of interest; a routine for saving the changes in the region of interest separately without affecting the image; and a routine for retrieving the changed region of interest along with the image, without affecting the image.

Various other features, objects, and advantages of the invention will be made apparent to those skilled in the art from the accompanying drawings and detailed description thereof.

### BRIEF DESCRIPTION OF THE DRAWINGS

FIG. 1 is a flowchart illustrating a region based image modification method as described in an embodiment of the invention;

FIG. 2 is a block diagram of a tool performing region based modification as described in an embodiment of the invention;

FIG. 3 is a flowchart illustrating a diagnostic decision support method as described in an embodiment of the invention;

FIG. 4 is a block diagram of an image management system as described in an embodiment of the invention; and

FIG. 5A to FIG. 5F show a diagrammatic illustration of region based modification of the images as described in an exemplary embodiment of the invention.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

In various embodiments, a region based image modification method and system are disclosed. The method includes selecting at least one region of interest and modifying the same and saving the changes in the region of interest without affecting the original image. In an example, an image and corresponding edited regions of interest can be saved in a single file, so that the images along with regions of interest or image alone or one or more regions of interest may be accessed separately. The original image can be retrieved without any changes, but at the same time the changes incorporated in the selected regions of interest can be retrieved separately.

In an embodiment the invention provides a method of selecting different regions of interest of an image and modifying each region of interest with different image properties and saving the same without affecting the original image. In an example, each region of interest is saved as independent images and they behave as independent images with individual image properties or visualization characteristics. The editing of region of interest is preformed such that it does not affect the original image

In an embodiment a tool is provided to modify at least one region of interest of an image and access the changed region of interest as and when required, with or without accessing the original image.

In an embodiment an image management system is provided wherein at least one region of interest is selected, edited and saved. The image along with regions of interest or regions of interest alone or selected regions of interest can be displayed or transmitted to an external device.

The term “region of interest” indicates any part of the image that need to be analyzed or viewed in detail and further the term “editing” or “modification” includes different possible changes that could be made to an image and need not be limited to the few examples mentioned in the specification.

Even though the invention is explained with reference to medical images, the image need not be limited to medical images. The technique is applicable to different images including industrial images, photographic images, etc. The images may also include two-dimensional, three-dimensional or video or cine images. Further the application of the invention need not be limited to images. The method is applicable to any documents, menus or files, where a part of the document or menu needs to be selected, edited and saved separately without affecting the main document or menu.

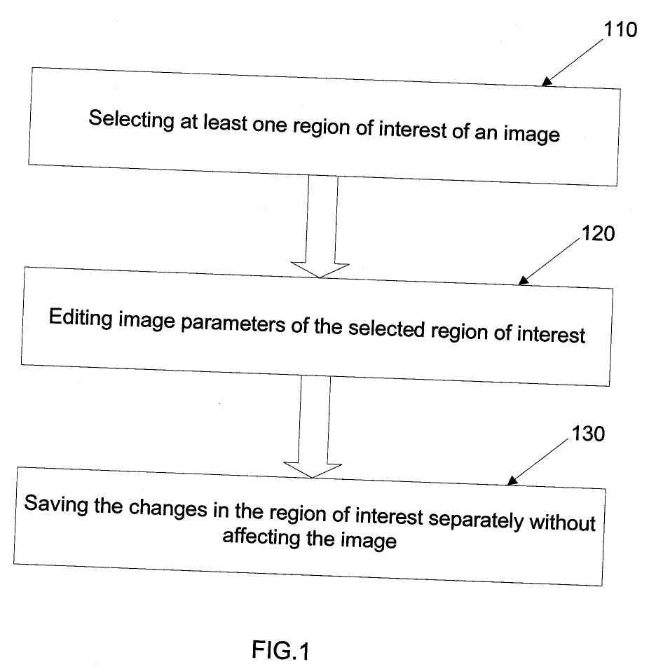

FIG. 1 is a flowchart illustrating a region based image modification method as described in an embodiment of the invention. At step 110, at least one region of interest is selected. The region of interest can be selected using different existing techniques. Multiple regions of interest can be selected simultaneously or sequentially. At step 120, image properties of the selected regions of interest are edited. The image properties might include imaging attributes such as contrast, brightness, sharpness, etc. and display parameters or visualization properties might include size, color, etc. The image properties of the selected regions of interest are modified without affecting other parts of the image. The modification is performed on each region of interest and each region of interest may have different image attributes or visualization properties. The image properties of multiple selected regions of interest can be edited simultaneously, if the modification need to be incorporated is same for all the selected regions of interest. Alternately, individual regions of interest may be edited separately to have different image properties for each region of interest. In an embodiment, while editing the regions of interest, the regions of interest may be annotated. The step may further include marking the edited region of interest for identifying the same. The marking can be done in a visible or non-visible format. Watermarking techniques may used to mark the images in an invisible format. At step 130, the images are saved along with the regions of interest such that the image is not affected, but still are able to retrieve the changes made in the region of interest. In an example, the region of interest are saved as separate image. Each region of interest can have different imaging parameters or attributes and can be saved separately. The original image is saved without any changes. In an example, the original image is indicated with the edited region of interest. For example, there could be small or hidden markings on the image indicating the position of the edited regions of interest. By clicking on the markings, the region of interest can be accessed, displaying the edited changes. In an embodiment, the images are displayed as images coexisted with the edited region of interests. In an example, the edited region of interest may be displayed with original image at the background. In another example, the original image and the regions of interest can be displayed on the same window. Both the image and regions of interest incorporating the changes can be viewed on the same window simultaneously. In an embodiment the region of interest may be compressed to maintain the size of the image. The method might further include transferring images to an external source or to a server. The image may be transferred or displayed along with the regions of interest, alternately all or the selected edited regions of interest may be transmitted or displayed.

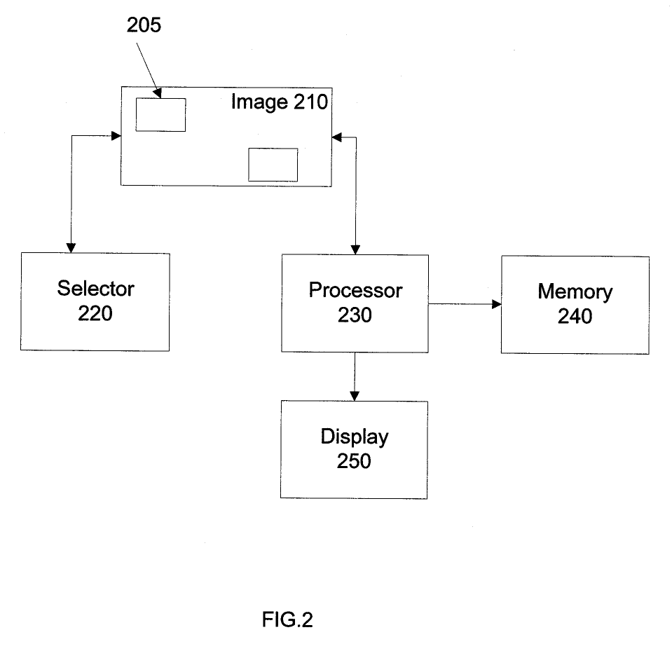

FIG. 2 is a block diagram of a tool for performing region based image modification as described in an embodiment of the invention. An image 210 that needs to be investigated can be fetched from a database and may be displayed on a display 250. Multiple regions of interest 205 can be selected on the image 210. A selector 220 is configured to select the regions of interest. A user may intervene in selecting the regions of interest 205. The user, with the assistance of the selector 220, may select desired region interest 205 from the image 210. The user may select multiple regions of interest 205 at the same time. The selector 220 is configured to feed the selected regions of interest 205 to a processor 230. The processor 230 is configured to edit the selected region of interest 205 without affecting other parts of the image. The processor 230 may edit each region of interest 205 separately or together. The processor 230 may edit the image parameters such as image attributes, display parameters, etc. of the image 210. While editing, the image 210 may be annotated. The processor 230 is configured to mark the edited regions of interest 205 and to incorporate the same on the image to identify the edited regions of interest. The processor 230 further saves the edited regions of interest 205 and the image 210 separately in a memory 240. The memory 240 may be associated with the tool or could be an external memory storage device. The image 210 and the region of interest 205 are saved such that the changes made in the regions of interest 205 do not affect the image 210. The changes in the regions of interest 205 are stored separately and they act as individual images, but the images and the changed regions of interest can be save in same memory file. In an embodiment, the image 210 is provided with markings indicating the edited region of interest 205. The image 210 and the regions of interest 205 are displayed on the display 250.

In an embodiment, while accessing the regions of interest 205, the regions of interest 205 can be displayed with the image 210 on the background. The regions of interest 205 and the image 210 may be displayed on the same window simultaneously. While displaying, the image 210 is displayed without any change. In some examples markings may be provided on the image 210 indicating the edited regions of interest 205. In an example the image 210 may be displayed without any indication about the edited regions of interest 205. Alternately the edited regions of interest 205 may be displayed without displaying the image 210.

In an example the edited regions of interests 205 may be provided with annotations regarding the modifications, including the details of changes incorporated in the image attributes. Alternately the regions of interest may be provided with a link to a document, wherein the details of the editing could be saved in the document. The document could be saved in the memory along with the image and the corresponding edited regions of interest.

In an example the access of the edited regions of interest may be controlled using a password protection. This facilitates unwanted or unauthorized editing of the regions of interest. Depending on the need different access permissions may be provided.

In an example the image along with the edited regions of interest or image alone or one or more regions of interest may be transmitted to a location within the system or to an external device.

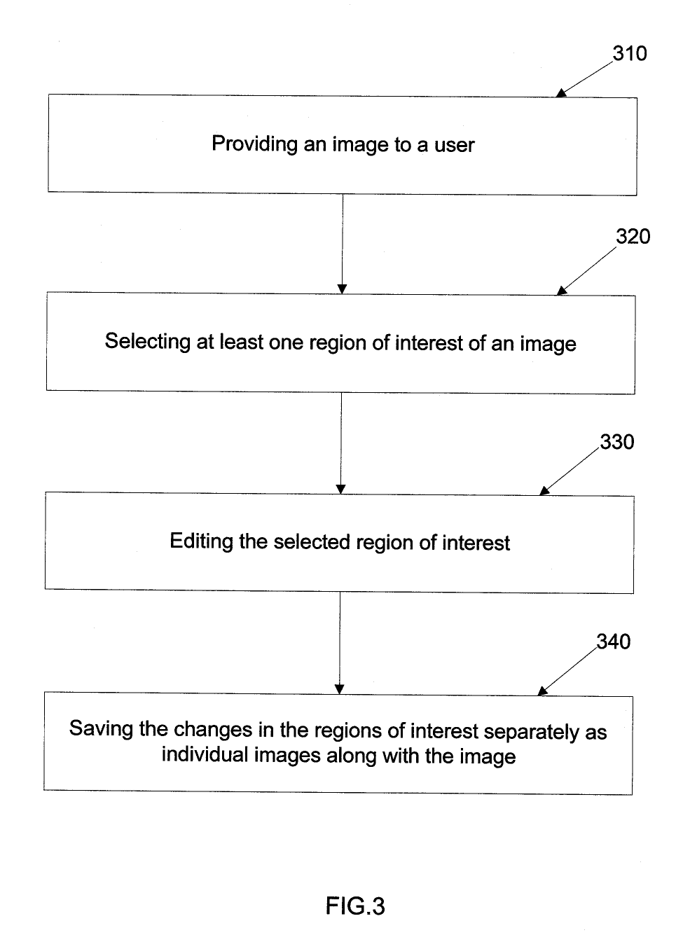

FIG. 3 is a flowchart illustrating a diagnostic support method as described in an embodiment of the invention. The images are interrogated for assisting in a decision support. The diagnostic support through investigation of images may be used in medical domain, industrial domain etc. The method is explained with reference to a medical domain. However the application of the method need not be limited to this. At step 310, an image to be interrogated for diagnosis is provided to a user. In medical domain the user may be a physician and the image may be medical image obtained from an imaging device or an image storage device. The image is displayed to the user. At step 320, the user identifies the region of interest and might select multiple of regions of interest. The physician may himself identify the regions of interest. Different tools are available in assisting him to select different regions of interest. At step 330, the physician may edit the region of interest based on his requirement. The physician might adjust the image attribute or display parameters of the selected region of interest. At step 340, the image is saved with the edited regions of interest. The regions of interest and image are saved as individual images and the image does not reflect the changes incorporated in the region of interest. The regions of interest may be indicated with a marking on the image so that the edited regions of interest can be identified easily. Once the image and the regions of interest are stored, the image will be displayed as the initial image without indicating any changes. Upon accessing the region of interest, the region of interest is displayed with all the modified changes. The region of interest could be displayed on the same window along with the image. This will help the physician in analyzing the image with all necessary modification he would like to have, but without affecting the image. If the properties of the image are changed, then it will be difficult for another physician to evaluate the image. Since the edited regions of interest are saved separately, whenever the physician needs to review the edited region of interest it could be accessed easily. Further each region of interest could be provided with different image attribute or display parameters.

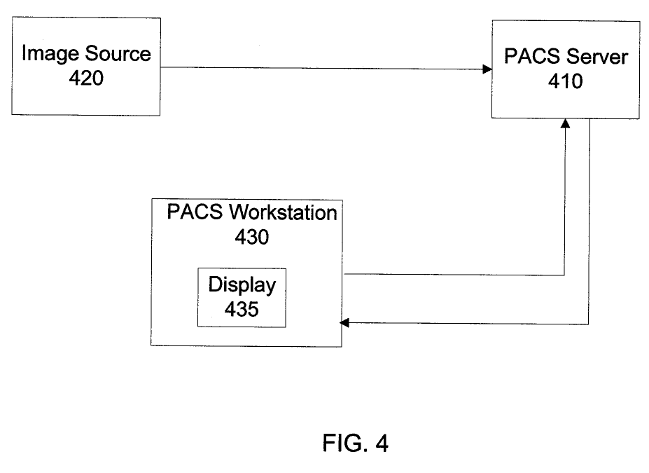

FIG. 4 is a block diagram of an image management system as described in an embodiment of the invention. The image management system is explained with reference to a picture archival and communications system (PACS) system. However the system could include any imaging modalities or any imaging system. The image management system includes a PACS server 410 having plurality of inputs and outputs. The inputs are configured to receive image information signals and outputs are configured to provide image output signals. The PACS server 410 may receive image information signal from an image source 420. The image source 420 could be any imaging device or any database stored with the images. In an example the imaging source can be any medical imaging device including MR, CT, X-Ray, ultrasound, PET etc. Medical images are generally stored in DICOM format. The system further comprises a PACS workstation 430 configured to receive input from the PACS server 410. From the image received, at least one region of interest is selected and the selected region of interest is edited based on the user need. The edited region of interest is stored in the PACS server 410 separately with the image. The regions of inertest will also act as individual images having its own image properties. The PACS workstation 430 is further provided with a display 435 for displaying the image. The image is retrieved from the PACS server 410 and is displayed on the display 435. The image displayed will not show the modification incorporated in the region of interest. The image might have some markings on the image indicting the position of the region of interest. The PACS workstation 430 may provide the markings on the image at the time of editing the regions of interest. Further the images may be transferred to another storage media along with the regions of interest. Alternately the image alone or regions of interest alone may be transferred. It is also possible to transfer, selected region of interest with or without the original image.

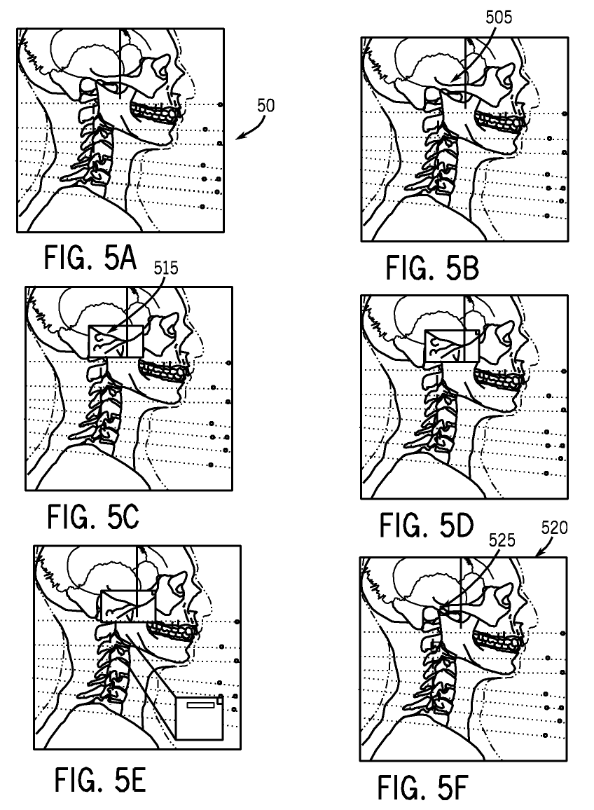

FIG. 5A to FIG. 5F show a diagrammatic illustration of region based modification of the images as described in an exemplary embodiment of the invention. FIG. 5A shows an original image 510 that is to be evaluated by a user. In the example, a medical image is shown. FIG. 5B shows the selection of a region of interest 505 of an image. Multiple regions of interest 505 may be selected. FIG. 5C shows editing the selected region of interest 505 without affecting other parts of the image or the changes incorporated are confined to the selected regions of interest. The edited region of interest is represented as 515. Modification might include changing image attribute such as brightness, sharpness, contrast etc and display parameters such as size, color etc. FIG. 5D shows saving the image 510 along with the edited region of interest 515. It is to be noted that the image 510 will be saved as such and the edited region of interest 515 will be saved separately without affecting the image. Both the image and edited regions of interest could be saved in a single file in a memory. FIG. 5E shows selection, editing and saving of another region of interest. In the example shown, the region of interest is annotated. FIG. 5F shows the image retrieved after the modification process. It is to be noted that image 520 displayed is similar to the initial original image 510. In an embodiment the retrieved image 520 is provided with markings 525 so that the physician or another person will be able to identify the edited region of interest 515. By clicking the markings 525 on the retrieved image 520, the edited region of interest 515 may be accessed. The edited region of interest 515 may be displayed showing all the modifications incorporated.

Some of the advantages of the invention include editing and changing properties of selected region of interest. This will provide more visual clarity while investigating the image. Each user may prefer to view a region of interest in accordance with their choice of image attributes. So even if a physician edits the region of interest, the original image is not changed and hence another physician can select his region of interest and make changes of his own choice. Once the changes are made the physician might like to retrieve the modified region of interest and this could be used in assisting a clinician in providing clinical decision. Since multiple region of interest can be selected and retained, it is more convenient in image making modifications. Each region of interest is configured to act as individual images without affecting the original image and this will help in retaining the original image as well as the modifications incorporated in the region of interest. Further some of the visualization methods like bone-subtraction, viewing the blood vessels, a 3D view of the regions of interest selected, image registration using images of the same size from various modalities, etc. can be applied independently to each region of interest. The technique applied to one region of interest need not be the same as that applied to another region of interest.

Further the ability to select multiple regions of interest, each behaving as independent images, gives the physician a lot of flexibility to study the critical areas on the image keeping the original image (as a reference) in the background. Thus technique allows the physician to present his ideas about the case in a better and easier way. Also this method will provide the doctor a one-screen-view of all the changes done to the various regions of interest thus saving him the trouble of navigating between several screens, each containing a different visualizing property that he might have applied.

The above-description of the embodiments of the methods and tools has the technical effect of modifying various regions of an image without affecting the image. The method and system will act as a decision support to the clinician as the selected region of interest may be modified and retrieved without affecting the image. The technical effect of the method and system disclosed includes using existing imagine techniques to at least one part of the image and retaining the changes with out affecting the original image.

Thus various embodiments of the invention describe a method and system for region based image modification. Another aspect of the invention is to provide an image management system.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Exemplary embodiments are described above in detail. The assemblies and methods are not limited to the specific embodiments described herein, but rather, components of each assembly and/or method may be utilized independently and separately from other components described herein. Further the steps involved in the workflow need not follow the sequence in which there are illustrated in figures and all the steps in the work flow need not be performed necessarily to complete the method.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

We claim:

1. A region based image modification method comprising the steps of:
selecting at least one region of interest of an image;
editing image parameters of the selected region of interest; and
saving the changes in the region of interest separately without affecting the image.

2. A method as in claim 1, wherein the step of editing image parameters includes:
changing image attributes or display parameters of the selected region of interest, without affecting the other parts of the image.

3. A method as in claim 2, wherein the step of editing includes: changing the image parameters of various regions of interest of an image simultaneously.

4. A method as in claim 2, wherein the step of editing includes: changing the image parameters of various regions of interest sequentially.

5. A method as in claim 1, further comprising: marking the region of interest while editing the region of interest.

6. A method as in claim 1, wherein the step of saving includes: saving the edited regions of interest separately as individual images.

7. A method as in claim 6, wherein the step of saving includes: saving the image along with the markings indicating the edited regions of interest.

8. A method as in claim 1, further comprising: displaying the image coexisted with the edited region of interests.

9. A method as in claim 1, further comprising: displaying the region of interest with the incorporated changes upon accessing the region of interest.

10. A method as in claim 1, further comprising: transferring selected edited region of interests separately or along with the images to an external device.

11. A method as in claim 1, further comprising: compressing the one or more edited regions of interest to maintain the size of the image.

12. A tool for region based image modification comprising:
a selector for selecting at least one region of interest of an image; and
a processor, configured to edit the selected region of interest without affecting other parts of the image, and further configured to save the edited region of interest and the original image separately.

13. A tool as in claim 12, wherein the image includes a two dimensional, three-dimensional or a moving image.

14. A tool as in claim 12, further comprising: a memory for storing the image along with the edited regions of interest.

15. A tool as in claim 12, wherein the processor is further configured to mark the edited regions of interest.

16. A tool as in claim 15, wherein the processor is configured to display the image without any changes.

17. A diagnostic decision support method comprising the steps of:
providing a medical image to a user;
selecting at least one region of interest of the image;
editing the selected region of interest for assisting in diagnosis; and
saving the region of interest and the image separately as individual images to enable retrieval of the edited region of interest along with the original unchanged image.

18. A method as in claim 17, wherein the step of editing comprises: modifying image parameters including image attributes and display parameters of the selected region of interest, sequentially or simultaneously.

19. A method as in claim 17, further comprising: providing an indication on the image about the edited regions of interest.

20. A method as in claim 17, further comprising: retrieving the image without any changes.

21. A method as in claim 20, further comprising: retrieving the edited region of interest without affecting the image.

22. An image management system comprising:
a picture archival and communications system (PACS) server having a plurality of inputs and outputs, the inputs configured to receive image information signals and the outputs configured to provide image output signals;
an image source having outputs coupled to at least one of the inputs of the PACS server, and configured to provide an image signal for storing images at the PACS server; and
a PACS workstation having an input coupled to at least one of the outputs of the PACS server, and configured to receive the images from the server, and further configured to edit a selected a region of interest and store the edited region of interest without affecting the image on to the PACS server.

23. The system as in claim 22, wherein the PACS station is further provided with a display configured for displaying the image with markings indicting the edited regions of interest.

24. The system as in claim 23, wherein the display is further configured to display the edited region of interest and the image.

25. A computer readable medium having one or more computer readable media for performing region based modification of an image comprising:
a routine for selecting at least one region of interest of an image;
a routine for editing image parameters of the selected region of interest;
a routine for saving the changes in the region of interest separately without affecting the image; and
a routine for retrieving the changed region of interest along with the image, without affecting the image.
